(19) United States
(12) Patent Application Publication
(10) Pub. No.: US 2026/0278549 A1
(43) Pub. Date: Sep. 17, 2026

(54) TOTAL PEOPLE OPERATIONS PLATFORM WITH ADVANCED AI TRAINING AND PROCUREMENT SYSTEM AND METHOD

(71) Applicant: MOTHERSHIP IP, LLC, Miami Beach, FL (US)

(72) Inventor: Ilyse Shuster, Lighthouse Point, FL (US)

(21) Appl. No.: 19/672,297

(22) Filed: May 8, 2026

Related U.S. Application Data
(63) Continuation-in-part of application No. 19/665,823, filed on May 1, 2026.
Application No. 19/665,823 is a continuation of application No. 17/894,260, filed on Aug. 24, 2022, now abandoned.
Application No. 17/894,260 is a continuation-in-part of application No. 17/882,166, filed on Aug. 5, 2022, now abandoned.
Application No. 17/882,166 is a continuation-in-part of application No. 17/346,187, filed on Jun. 11, 2021, now abandoned.

(51) Int. Cl. G06Q 10/101; G06Q 20/06

(52) U.S. Cl. CPC G06Q 10/101; G06Q 20/065

(57) ABSTRACT

An AI-native total people operations platform integrates a multi-module suite in which a workflow module serves as a digital collaboration and human, AI, machine and model training tool with a milestone-based double approval mechanism, alongside an AI Lab with a one-to-one agent training interface, onboarding, payments, digital skilling, learning e-commerce, physical workspace booking and mobility, and business services modules, each enriching agent and model training. A data lake stores artifacts categorized by a tagging pipeline to a task and skill ontology with lineage in a provenance subsystem. A training orchestrator fine-tunes foundational and large language models into governed AI agents. Workers can own their digital IDs and one-to-one agents; and People OS agents can be owned by the enterprise or People OS client, with client-approved data shareable back to digital IDs for one-to-one agent training. Payments support traditional currency, tokens, cryptocurrency, subscription, and SaaS mechanisms.

### CROSS-REFERENCE TO RELATED APPLICATIONS

This application is a continuation-in-part of U.S. Patent Application No. 19/665,823 filed May 1, 2026, which is a continuation of U.S. Patent Application No. 17/894,260 filed August 24, 2022, which is a continuation-in-part of U.S. Patent Application No. 17/882,166, filed on August 5, 2022, which is a continuation-in-part of U.S. Patent Application No. 17/346,187 filed on June 11, 2021, the disclosures of which are incorporated herein by reference in their entirety.

### BRIEF DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure invention and is not meant to limit the inventive concepts disclosed herein.

The accompanying drawings, which are incorporated in and constitute a part of the specification, illustrate embodiments of the disclosure and together with the general description of the disclosure given above and the detailed description of the drawings, given below, explain the principles of the disclosure.

In the drawings:

FIG. 1 is a system environment, according to an embodiment.

FIG. 2 describes a method for using the system, according to an embodiment.

FIG. 3 is a schematic of the sourcing functionality, according to an embodiment.

FIG. 4 is a computing environment, according to an embodiment.

FIG. 5 is a system-level diagram of the AI Lab architecture layered on the platform host, depicting the data lake, tagging pipeline, provenance subsystem, training orchestrator, agent factory, policy engine, and workflow runtime, according to an embodiment.

FIG. 6 is a data flow diagram for the tagging and training pipeline, showing how milestone approvals, deliverables, communications, demonstrations, and execution logs are normalized, assembled into corpora, and used for training, according to an embodiment.

FIG. 7 is an agent lifecycle diagram showing agent creation, registration, deployment, governance gates, usage metering, monitoring, feedback loops, and selective unlearning paths, according to an embodiment.

FIG. 8 depicts the nested user interface architecture, multi-folder workflow, and tiered systems.

The drawings are not necessarily to scale. In certain instances, details that are not necessary for an understanding of the disclosure or that render other details difficult to perceive may have been omitted. It should be understood, of course, that the disclosure is not necessarily limited to the embodiments illustrated herein.

### DETAILED DESCRIPTION

The present invention provides its benefits across a broad spectrum of endeavors. It is applicant’s intent that this specification and the claims appended hereto be accorded a breadth in keeping with the scope and spirit of the invention being disclosed despite what might appear to be limiting language imposed by the requirements of referring to the specific examples disclosed. Thus, to acquaint persons skilled in the pertinent arts most closely related to the present invention, a preferred embodiment of the system is disclosed for the purpose of illustrating the nature of the invention. The embodiments described herein are illustrative, and as will become apparent to those skilled in the art, can be modified in numerous ways within the scope and spirit of the invention, the invention being measured by the appended claims and not by the details of the specification.

Although the following text sets forth a detailed description of numerous different embodiments, the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined herein, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word "means" and a function without the recital of any structure, it is not intended that the scope of any claim element be interpreted based on the application of 35 U.S.C. § 112, subparagraph (f).

### Overview of Workflow Management System, Method, and AI-Native Platform

The present invention comprises various embodiments of a computer-implemented workflow and project management system and method including (1) client-provider matching; (2) project management including a double approval mechanism that allows users and providers (workers, employees, freelancers, etc…) to manage projects, milestones, notes, and overall deliverables effectively and efficiently; (3) programmatic payment functionality; and (4) personnel sourcing functionality. The invention addresses the common problem where while one or both parties initially agree to a certain project scope, the scope and expectations of the parties can change over time and the project often gets off track from the original agreement/scope. The invention’s double approval process ensures that clients and providers (workers, employees, freelancers, etc…) are always approving and agreeing to every project milestone and every project note before tasks are started, thereby ensuring that neither party can assert that it did not understand the project scope. The invention differs from traditional task or checklists because instead of the client or provider (worker, employee, freelancer, etc…)just reviewing the notes/tasks, they must take an affirmative step to “approve” the notes/tasks, such as by clicking an “approve” button. This affirmative step functions as a formal/written agreement and is recorded by the system with date and time stamps. The invention allows for on-platform communication tools with call recording, along with screen and time tracking to justify worker time spent and task execution. The invention is also enabled with programmatic payment functionality so that the provider gets paid by the client only upon confirmed completion of the applicable notes, milestones, and tasks for a given project. Additionally, in some embodiments, the system is enabled with sourcing functionality which integrates one or more external and/or one or more internal databases, clearinghouses, or service bureaus from which the system can obtain data and information relating to tasks, potential users, and users (including Providers and Clients, as defined and discussed below).

The system described herein is also referred to as the “People OS” platform, a multi-module suite in which a workflow module, comprising a digital collaboration and human, AI, machine and model training tool, operates as the nucleus and is supported and enriched by a plurality of additional modules including, without limitation, an AI Lab module (including a one-to-one (1-1) agent training interface as described below), an onboarding module, a payments module, a digital skilling module, a learning e-commerce and learning programs module, a workspace module (described further below) that supports booking and management of physical workspaces such as pods and workstations together with mobility tracking and enablement, and a business services module. Each module of the People OS suite enriches the data available for, and the learning and training of, the AI agents and models described herein, whether or not the workflow module is invoked for a given activity. The workflow module is a digital collaboration and human, AI, machine and model training tool and is distinct from the workspace module, which addresses physical workspaces and the on-platform booking, mobility, and related functionality associated therewith. Modules of the People OS suite may be used in silo and will still inform the agents and models, and are often used in addition to one another. The People OS platform allows workers, clients or employers, and AI agents to interact and work together across the multi-module suite, with the workflow module serving as the principal digital collaboration surface. As described in further detail below, in some embodiments AI agents trained on a one-to-one (1-1) basis through the AI Lab’s one-to-one agent training interface and bound to a worker’s digital ID are owned by that individual worker (the “digital ID agents”), whereas AI agents trained primarily within an Enterprise or People OS client deployment (the “People OS agents”) are owned by the Enterprise or People OS client, with designated People OS client-approved data and learnings able to be shared back to digital IDs and used for one-to-one (1-1) agent training as described below.

### Network-Enabled Platform Host and User Account Creation

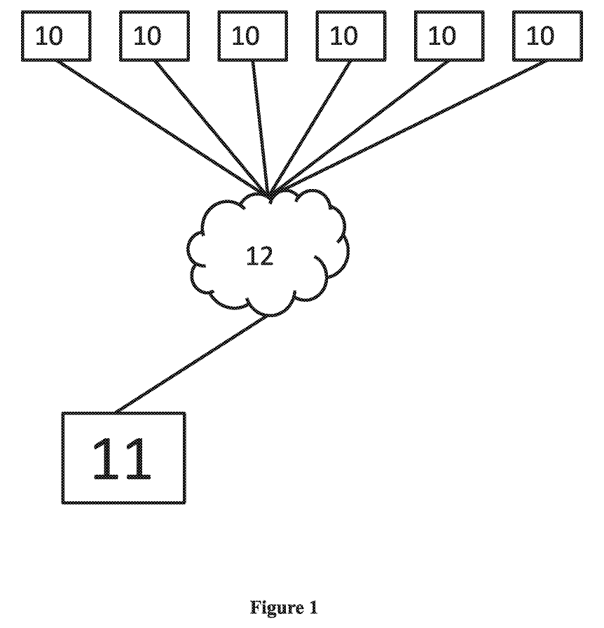

FIG. 1 illustrates one embodiment of an information system that facilitates management and execution of the system methods described herein. The system includes one or more user devices 10 that users use to communicate with the at least one system platform host 11. The user devices 10 and the host 11 are in communication over a communications network 12 such that the user device 10 can access the host 11 to send and receive data thereto and therefrom. In some embodiments, communications network 12 comprises the Internet, cellular network, satellite network, RF communication, Bluetooth-type communication, near field, or any other form of communication network capable of facilitating communication between user devices 10 and host 11. The information system, in some embodiments, comprises an internet-enabled computing system whereby the user devices 10 access an online and internet-based platform served by the platform host 11 which hosts the interactive graphical user interface and facilitates and carries out the methods described herein.

A communications link is established between a plurality of user devices 10 and the platform host 11. The platform host 11 receives a request from one or more user devices 10 to establish an account. The request includes one or more user-specific data points such as registration information to the platform host 11 including name, username, e-mail address, date of birth, billing address, password, payment information, availability, area of expertise, professional qualifications, industry type, years of experience, personality type, and the like. The platform host 11 establishes an account based on the user data points. The platform host 11 registers an account associated with the user device 10 and validates the user associated with the user device 10 going forward. The platform host 11 assigns to each registered user an encrypted storage unit (for example, cloud storage) that contains all of the user’s data, information, documents, and the like associated therewith. In some embodiments, the platform host 11 assigns a role to each registered user, including a “Client” and a “Provider,” it being understood that a Provider is the party assigned (or seeking assignment) to do work and complete tasks and milestones specified by the Client and “Client” is understood to be the party assigning, training, or management the work (for example as an employer). It should be noted that the term “task” as referred to herein shall be construed broadly to include any type of job or project or portion thereof assigned by a user to another user (for example, by a Client to a Provider). In some embodiments, a task can include training, orientation, learning, development, preparation, drafting, designing, authoring, or combinations thereof.

In some embodiments, the platform host 11 makes available a graphical user interface based on the account data points, which user interface includes a plurality of workflow and project management functions. In some embodiments, upon account registration the system automatically enables a cloud-based document management and creation platform, such that the user can create, modify, and share documents and work product directly from within the system environment.

The system and method described herein can be delivered in a variety of ways including via a desktop application, a mobile application, through a wide area network, such as a cloud-based or online computing environment, or through a local area network. Accordingly, the system is designed and flexible and scalable with various formats of user devices including personal computers, tablets, mobile devices, and virtual devices.

### Client-Provider Matching

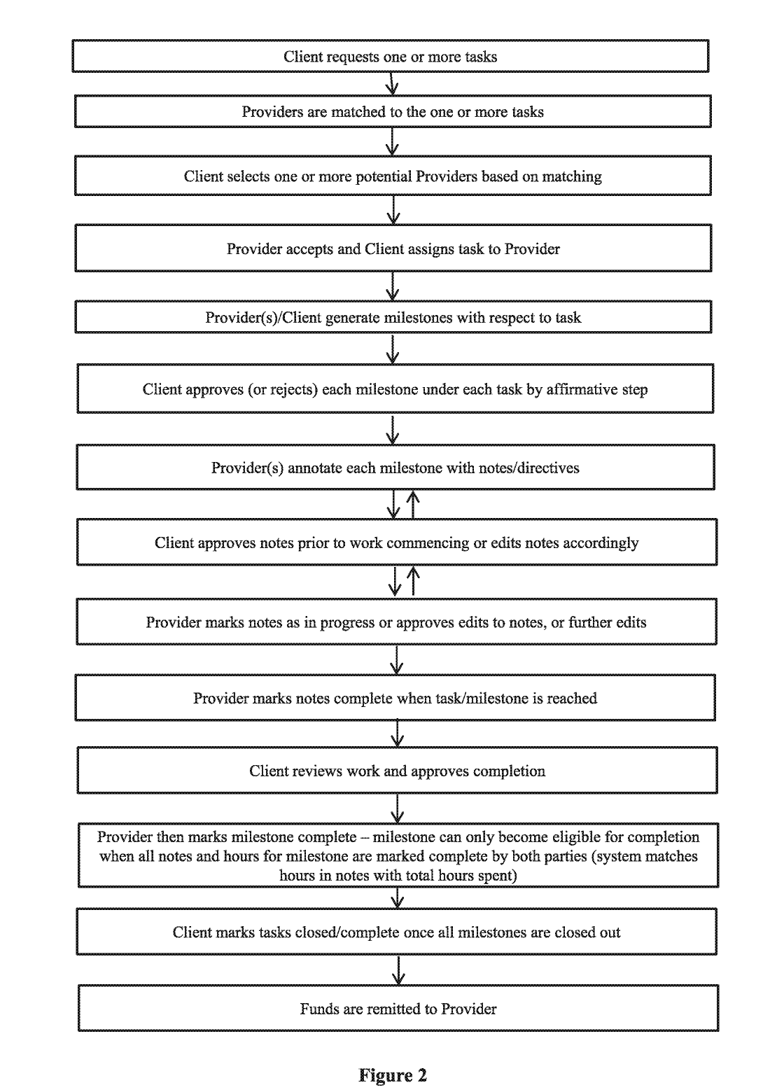

With reference to FIG. 2, shown is an example of the method steps associated with one embodiment of the invention. As noted above, in some embodiments system users are assigned a role either as a Client or a Provider, with the Client being the requesting and paying party, and the Provider being the party assigned to carry out a task or project through to completion. Initially, a Client requests one or more tasks by inputting appropriate task data points into the system.

In some embodiments, the platform host 11 is enabled to match Providers with Clients based on the compatibility of user-specific and/or task-specific data points provided by the user either during the registration process or otherwise, for example, when a Client requests a specific task. The platform host 11 is enabled to compare data points from the Client side with those on the Provider side and can output to the Client a list or ranking of the compatibility of a determined set of Providers. For example, the ranking can be based on the percentage of matching data points. It is appreciated that the platform host 11 can match Providers to Clients based on a variety of user data points and/or task data points. In some embodiments, matching occurs automatically by the platform host or matching may be carried out manually through user input, for example by system inputs from the Client including sorting through a set of data points associated with Provider(s). Still yet, in some embodiments, the matching process can be carried out through artificial intelligence by configuring the platform host 11 with machine learning functionality, either locally or remotely.

In embodiments employing machine learning for client-provider matching, the machine learning module may be trained on historical matching data comprising prior task assignments, completion outcomes, client and provider feedback, provider performance metrics, and user-specific data point correlations. The training process may employ supervised learning techniques where successful matches are used as positive training examples and unsuccessful matches as negative examples. The trained machine learning model outputs a compatibility score or ranking for potential provider matches based on learned patterns and correlations between task-specific and user-specific data points. In some embodiments, the machine learning module is continuously updated based on new matching outcomes to improve prediction accuracy over time.

Following a Client task request and matching, the Client can then select which Provider(s) the Client is interested in engaging for the task. The selected Providers are then notified of the Client task request, can review and preliminarily accept the task, and a notification of preliminary acceptance can be sent to the Client. The Client can then choose to accept or reject the offer from the selected Provider(s) or choose to wait for additional Providers (or send another task request). Once the Client approves of a Provider, then the one or more tasks is assigned to the Provider, now called the assigned Provider, and workflow management features for such tasks are enabled.

The method is further explained from a Client-side perspective, as follows: the Client requests one or more tasks by inputting appropriate data into the system. Next, one or more Providers accepts each task, and the Client receives a notification of same. The Client can then choose to accept or reject the offer from the Provider(s) or choose to wait for additional Providers (or send another task request). If the Client approves the Provider, then the system transmits one or more approved tasks to be assigned to the Provider.

In some embodiments, upon user registration or task assignment, the platform host 11 generates and assigns a platform specific e-mail address, telephone number, messaging username, or like contact means for the user. In some embodiments, the contact means can be established in accordance with the Client’s specifications such that the assigned Provider has contact means associated with the Client’s domain.

### Work-Flow Management

The Provider and/or Client then generates milestones with respect to each task, the milestones being defined as sub-parts of the tasks. Next, the Client is sent a request to approve or reject each milestone by taking an affirmative step, i.e. a positive interaction with the system to generate a notification back to the Provider as to whether the task has been accepted (or rejected). As an optional step, the Provider then annotates each milestone with notes, such as deadlines, directives and goals for how each milestone will be achieved. The Client then reviews and either approves, rejects, or modifies the notes prior to work commencing. The Provider and Client engage in a back and forth regarding the milestone notes until the Client is satisfied with the directives to be undertaken and goals to be achieved for each milestone. Once the Client has approved the notes, milestones, and tasks, the Provider commences work.

As the project progresses, the Provider makes notes complete which then must be reviewed and approved by the Client. Only once the Client approves each note for a given milestone and the Provider confirms such completion can the milestone be deemed completed. The system is also configured to match the number of hours spent on a milestone to the number of hours budgeted for the overall project to assure that the Provider is staying on track with the scope of the project. The above process is repeated until all milestones for a given task are completed and approved by the Client. At that point, with all notes for each milestone completed and approved, and with each milestone completed and approved, the task is deemed completed and approved and funds are remitted to the Provider by the Client.

Next, the Client is sent a request to approve or reject each milestone, based on milestone data generated by the Provider. The Client takes an affirmative step, i.e. a positive interaction with the system, which generates a notification back to the Provider as to whether the task has been accepted (or rejected). The Client then receives and reviews and either approves, rejects, or modifies notes generated by the Provider prior to work commencing. Approval, rejection, or modification data is then sent to the Provider. Once the Client has approved the notes, milestones, and tasks, the Provider commences work based on a “start” notification initiated by the Client.

As the project progresses, the Provider makes notes complete which then are received by the Client for review and approval. Only once the Client approves each note for a given milestone and the Provider confirms such completion can the milestone be deemed completed. The above process is repeated until all milestones for a given task are completed and approved by the Client. At that point, with all notes for each milestone completed and approved, and with each milestone completed and approved, the task is deemed completed and approved and funds are remitted to the Provider by the Client. In some embodiments, workflow management functionality is supported by scheduling and calendaring with respect to one or more of the tasks, milestones, or notes to assure that the Provider is timely completing each assignment.

In some embodiments, workflow management functionality can be augmented by machine learning. For example, machine learning can be used to augment the approval step by providing data points to the Client that assist the Client in determining whether a task or milestone has been completed. In other scenarios, machine learning can automate the Client approval process, particularly for low level tasks or tasks that have purely objective completion requirements.

The machine learning augmentation of workflow management may include training the machine learning module on historical task and milestone data to recognize patterns indicative of successful completion. For tasks with objective completion requirements, the machine learning module may be configured to analyze submitted deliverables, time tracking data, and milestone annotations to generate an automated approval recommendation or, in some embodiments, to automatically approve completion without requiring affirmative client input. The machine learning module may further be configured to identify potential issues or delays by comparing current progress against historical completion patterns, and to alert the client or provider accordingly.

### Payment Functionality

In order to enhance project and workflow management, the system and method can optionally include various payment methodologies including the use of application programming interfaces (APIs) to third party payment processors to track and manage payments from the Client to the Provider. In some embodiments, a tokenized payment management system is implemented (either internally, or through an external API) whereby the cost of a project is scoped and then the client purchases through the system tokens which have a corresponding monetary value. The Client can then use the tokens as virtualized currency through which to pay Providers for tasks. In some embodiments, unused tokens (reflecting, for example, hours and/or dollars) can be retained by the Client and applied to other tasks or milestones or can be used to pay different Providers than the Provider to whom the tokens were initially designated. This allows the Client to control budgeting by pre-purchasing a predetermined number of tokens (with a corresponding currency value) and then initiating payment of tokens to Providers upon completion of tasks. In this way, the system can offer a payment management system to control or eliminate disputes regarding payment or pricing by and among the Clients and Providers. In some embodiments, the third-party payment processor and/or the tokenized payment system can be blockchain-enabled and/or can be configured to be compatible with cryptocurrency of various configurations. Additionally, in some embodiments, Provider earnings can be tracked and the Client may have the option to issue shares or other forms of equity to the Provider either through blockchain (for example, a non-fungible token) or traditional means. In some embodiments, payment processing (whether handled internally or through an external API) can be augmented by machine learning.

### User Experience

The system and method of the present invention can be enhanced through various communication protocols and functionality including email, text messaging, instant messaging, video conference, voice messaging and voice-over-IP audio communication options. The system also includes document management which allows for collaborative editing and review of documents and other deliverables. For example, the document management functionality can also be used to share approvals for projects, tasks, milestones, notes, and payments as outlined above.

### Sourcing and Human Resources Functionality

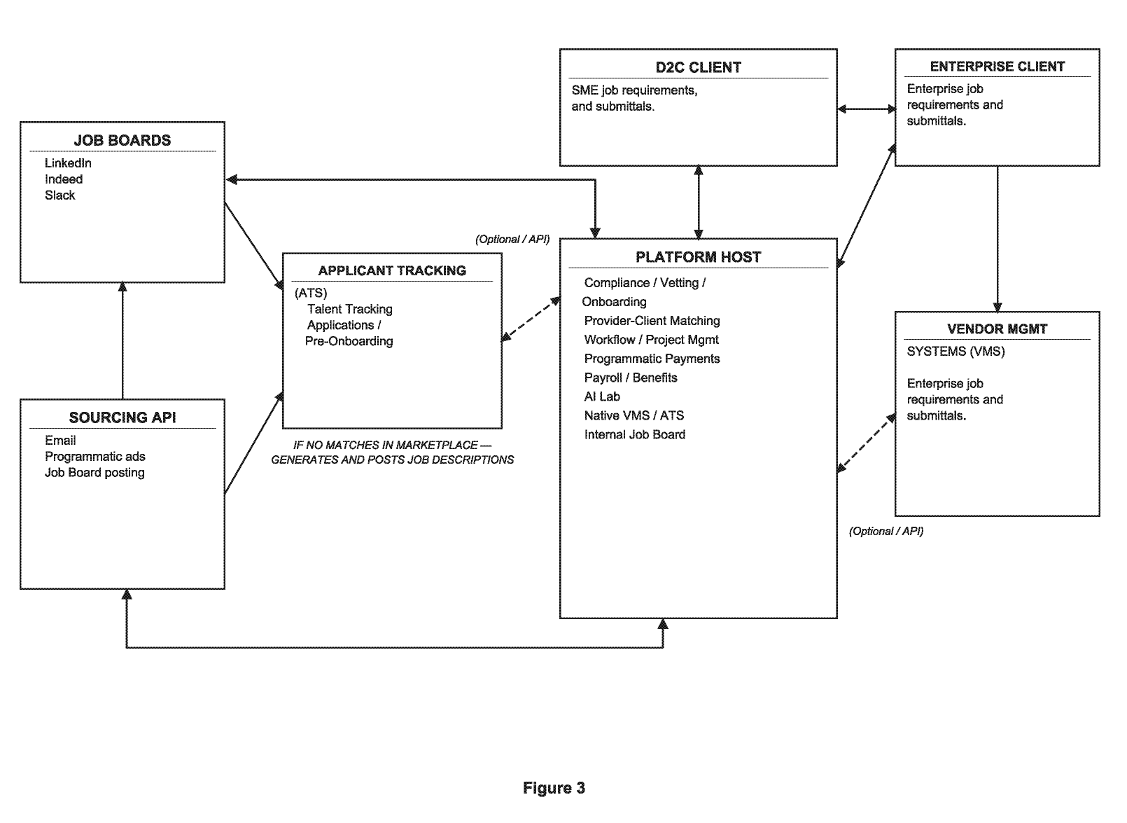

With reference to FIG. 3, shown is a schematic of a portion of the system enabled with sourcing functionality. As shown, in some embodiments the platform host 11 is interconnected with one or more supplemental systems comprising a sourcing management platform, which may include, for example, an Applicant Tracking System (ATS) and a Vendor Management System (VMS). In some cases, it is understood that an ATS is generally useful for more permanent or full-time engagements between a Client and multiple Providers where a VMS is useful for “one-off” or project-by-project engagements between a Client and multiple Providers. Here, the platform host 11 can be enabled with its own internal ATS and/or VMS platforms which are made accessible to Clients by the platform host 11 to the respective Client user devices 10 to enable Clients to manage their relationships with Providers. Alternatively, in some embodiments, the platform host 11 is configured to connect to and interact with third party ATS and VMS platforms by, for example, an application programming interface (API) or other connection, which allows Client user devices to interface their own external platforms into the workflow management system of the present invention. Implementation of these supplemental systems enhances the feature set and functionality of the platform host by providing various sourcing management functionality found in typical ATS or VMS systems and allow for greater management and control over a variety of Client-Provider relationships.

As shown in FIG. 3, VMS connectivity may be useful for “enterprise” clients that have pre-established VMS platforms with certain standard operating procedures or protocols for creating job requirements and submittals. Through a bi-directional communications link and connection with an external VMS, the platform host can send and receive task data points and task requests (and/or job and engagement or other data points) without the need for that data to be entered into and stored directly by the platform host. Client user devices can leverage ATS connectivity in a similar fashion. As a point of comparison, in some embodiments, non-enterprise client user devices (referred to in FIG. 3 as a “D2C Client”) interface directly with the platform host without the need for the more robust VMS.

In some embodiments the platform host is interconnected to a sourcing API either directly or via an internal or external ATS (or VMS). In some embodiments, the sourcing API is configured to interface with one or more external job board platforms (for example, LinkedIn, Indeed, Slack, and the like). In this way, the client user device can leverage the platform host (including the ATS/VMS, if enabled) to track and manage talent and interact with the platform host 11 to identify suitable provider user devices. In at least one example, if the platform host does not identify a suitable provider user device match for the client user device, it generates relevant job description data and sends a request to an external sourcing API which can automatically generate a job post on the external job board platform. External and/or public job postings can be established, which job postings are directly integrated into the data flows of the platform host so that potential Providers are sent directly to the platform host (and ATS/VMS, if enabled) when responding to the job post. This enables integrated and, in some embodiments, automatic registration of Provider user devices in direct response to a specific task request or other need. In some embodiments, the sourcing API functions to send e-mails or other job solicitations without the need for an external job board platform.

In some embodiments, the platform host is enabled to carry out a variety of human resource tasks including compliance, vetting, onboarding, training, payroll, and benefits functionality. In some embodiments, this functionality is carried out internally by a human resources management (HRM) platform within the ecosystem of platform host at the request of a client user device. In other embodiments, the platform host leverages its connectivity to supplemental systems, such as an ATS or VMS, and/or an external sourcing API which provide either replace or supplement functionality at the platform host. For example, a sourcing API may be configured as a clearinghouse or service bureau that can send and receive data regarding professional licenses, such that the platform host can confirm the identity and qualifications of a provider user device. Payroll and benefits management may also be supplemented in this way, with a source API connected to the platform host to enable transmission of benefits and payroll information to and from an external payroll/benefits management source. Such a payroll/benefits management source may also, alternatively, be coextensive with the ATS and/or VMS integrations. In some embodiments, sourcing functionality (whether internal or external) can be augmented by machine learning which can assist in a variety of sourcing tasks including interfacing with ATS, VMS, and HRM systems (including HRIS systems), sourcing APIs, and the like.

In some embodiments, the sourcing and matching functionality work in concert and can be leveraged to identify new or replacement Providers for particular tasks. For example, a Client can request that a Provider be replaced, which request can be processed through sourcing functionality to identify suitable replacements.

Machine learning augmentation of the sourcing functionality may include training on historical sourcing data, including job posting effectiveness, candidate quality metrics, and time-to-fill data across various job boards and sourcing channels. The machine learning module may optimize job description generation by analyzing which job posting attributes correlate with successful candidate acquisition. Additionally, the machine learning module may assist in compliance and vetting tasks by processing data from clearinghouses and service bureaus to verify professional qualifications, background information, and credential authenticity, thereby reducing manual review requirements and improving vetting accuracy. In some embodiments, the machine learning module may further be trained on operational sourcing data including data received from ATS, VMS, and HRM systems and sourcing APIs to continuously improve the effectiveness of sourcing tasks and provider identification.

### AI-Native Total People Operations Platform

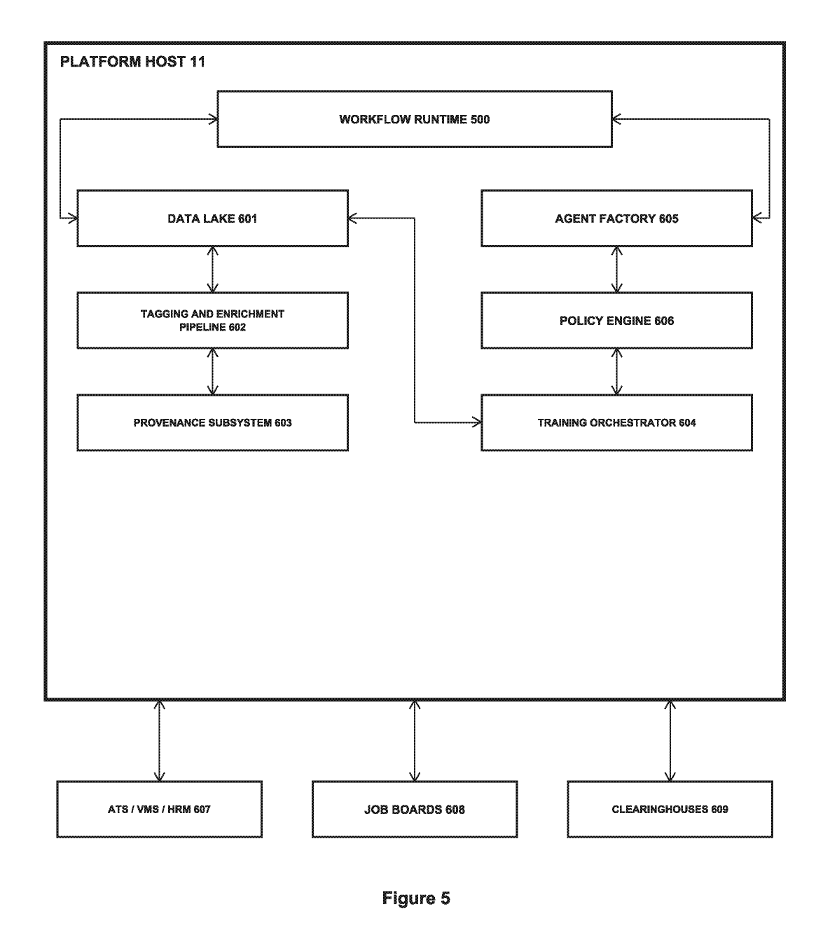

With reference to FIG. 5, shown is an embodiment of the system architecture expanded to encompass an AI-native total people operations platform. In this embodiment, the platform host 11 serves as both a system of execution for people operations workflows and a system of intelligent adaptation through a proprietary advanced AI training infrastructure. The platform host 11 continues to support the workflow and project management functions described above, including the double approval mechanism, scheduling and calendaring, on-platform communication tools with call recording, screen and time tracking, and programmatic payment functionality, which now also serve as primary data sources for AI training. The platform host 11 is further configured with an AI Lab layer comprising: a data lake, a tagging and enrichment pipeline, a provenance subsystem, a training orchestrator, an agent factory, and a policy engine, each of which is described below. In some embodiments, the platform host 11 functions as an expert system that directly feeds operational data and learned patterns into the proprietary advanced AI training infrastructure, thereby providing users with advanced AI agents, large language models (LLMs), foundational models, and artificial general intelligence (AGI) augmentation capabilities.

In some embodiments, the platform host 11 supports a distributed and privacy-preserving architecture wherein each total people platform and module maintains its own private data, machine learning (ML) models, foundational models (FMs), and large language models (LLMs) that can remain private and closed-source on designated client, talent, or mothership servers. The platform host 11 is configured to host proprietary AI assets in isolated storage and compute environments, enabling clients and providers to train and deploy advanced AI models without requiring disclosure of underlying data or model weights to other platform users or the network. Blockchain-enabled features, including those described herein for provenance tracking and tokenized payments, are offered as optional additions rather than mandatory components, permitting users to select their preferred infrastructure configuration while maintaining full functionality of the AI training and procurement system.

The platform host 11 further comprises a network sharing interface that enables Clients and Providers to selectively share their data, ML models, FMs, and LLMs with the network. The network sharing interface includes a share-to-network control through which users can elect to share with all on-network platforms or with specific designated on-network platforms by selecting corresponding options. Sharing preferences are recorded in the provenance subsystem along with timestamps and scope indicators. Access grants are revocable at any time through the network sharing interface, and upon revocation, the platform host 11 propagates access termination signals to affected network platforms and initiates selective unlearning procedures where applicable. Prior to sharing to each network, the platform host 11 generates and presents a network contract for digital review and electronic signature by the sharing user, with executed network contracts stored in the provenance subsystem and linked to the corresponding access grants.

The AI-native platform architecture reflects a unified system that combines reliable workflow execution with intelligent adaptation grounded in proprietary context. The combination of the workflow runtime (a system of execution) with the AI training and procurement stack (probabilistic capability) produces a system that can train, execute, and adapt. The value proposition of the platform is the integration of reliable training, workflow, intelligent adaptation, and proprietary context derived from operational data captured on the platform.

The sourcing and human resources features described above with reference to FIG. 3 are preserved and now interoperate with trained AI agents. In some embodiments, the platform host 11 and the AI Lab, including the D2C Client product offering of the AI Lab, are configured to connect directly to enterprise clients and to D2C Clients and to perform all Vendor Management System (VMS) and Applicant Tracking System (ATS) functions natively within the platform host 11, such that no external VMS or ATS is required. In other embodiments, where a client prefers to use its existing third-party VMS or ATS, or where the platform operator has established partner integrations with one or more third-party VMS or ATS providers, the platform host 11 and the AI Lab connect to those external VMS and ATS systems via APIs or other connections as described above. Similarly, the platform host 11 is configured in some embodiments to operate as its own internal job board through which Clients can post roles and Providers can discover engagements, and is additionally configured to connect to external job boards (for example, LinkedIn, Indeed, Slack, and the like) via the sourcing API described above. The People OS platform is itself configured to function as a VMS and an ATS, providing native vendor management and applicant tracking functionality across the multi-module suite, and is additionally configured to connect to and interoperate with other third-party VMS and ATS systems where a client or partner so elects. The platform host 11 continues to connect to ATS, VMS, job boards, and internal systems such as an internal job marketplace, via APIs, manage HR functions such as compliance, vetting, onboarding, training, payroll, and benefits functionality, and support identity confirmation via clearinghouses, while the AI Lab uses those integrations as both data sources and deployment surfaces for AI agents. In this way, the platform serves as a total people operations platform rather than solely a matching and sourcing system.

### Data Lake, Tagging Ontology, and Proprietary Context

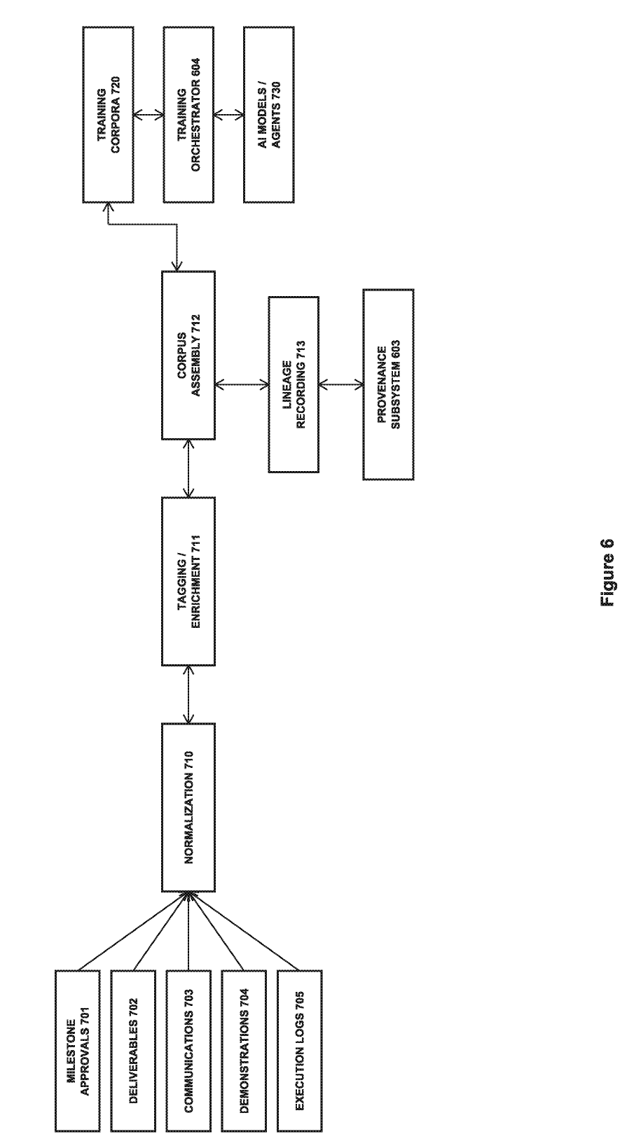

With reference to FIG. 6, shown is a data flow diagram of the tagging and training pipeline according to an embodiment. The data lake is a storage subsystem maintained by the platform host 11 that stores time-ordered workflow interactions, such as milestone requests and approvals, edits to notes and deliverables, budget-versus-actual hour traces, work product executions and recordings, and programmatic payment confirmations, alongside communications metadata and content where permitted by user consent. These artifacts, which were described above as operational elements of the workflow management and communication functionality, are now expressly defined as trainable signals for the AI training and procurement system.

The platform host 11 normalizes the stored data through a tagging and enrichment pipeline that maps events and artifacts to a tagging ontology comprising task schemas, skill taxonomies, approval categories, and outcome labels. The tagging ontology converts raw human-behavioral data captured during platform operations into machine-learning-ready corpora with typed events and feature vectors. The ontology includes categories for demonstrations, which are sequences of user actions and associated files that illustrate goal-directed task execution, and execution logs, which are captured traces of provider work and client feedback under the double approval mechanism described above. This tagging process categorizes large sets of data gathered from human behavior and execution into structured training sets suitable for producing AI agents.

The platform host 11 maintains a provenance subsystem that records consent, source system identifiers, and lineage metadata for each artifact in the data lake and each corpus produced by the tagging pipeline. The provenance subsystem enables downstream explainability and selective unlearning if required. In some embodiments, the provenance subsystem is implemented as an append-only log with optional blockchain-backed anchoring, building on the blockchain-enabled features described above with respect to payment processing, to ensure immutable lineage for training and inference events, consent states, and model and agent versions.

To harmonize people data across systems, the platform host 11 can construct a digital resume and digital ID as structured, verifiable profiles derived from the data lake and validated against external clearinghouses as described above. The digital resume aggregates verified skills, credentials, task history, and performance metrics for each user. The digital ID consolidates verified identity, credentials, and entitlements for each user. These constructs enable AI agents to consume and update verified skills and credentials under policy, and they are linked to the provenance subsystem to maintain ownership and auditability. Authorized operational data captured across the modules of the People OS suite, including data reflecting new skills acquired by a user during on-the-job execution, is routed to the AI Lab to enrich the user’s digital ID and associated digital persona for that user and for each of the user’s AI agents, and is reflected in the user’s digital resume substantially in real time, such that the digital resume and digital ID move with the worker and remain current as new skills, credentials, and execution history accumulate.

### Advanced AI Training and Procurement System

With continued reference to FIGS. 5 and 6, the platform host 11 includes a training orchestrator that transforms tagged corpora produced by the tagging pipeline into model-ready datasets for multiple training regimes. Supported training regimes include: supervised learning for matching and approval predictions using historical outcomes as labels; imitation learning from demonstrations where sequences of user actions are used as training examples for task execution patterns; and feedback learning derived from milestone accept/reject/edit events under the double approval process. The platform host 11 supports both batch training on historical corpora and real-time incremental updates to deployed models to maintain model relevance as new operational data is captured. The training orchestrator is configured to observe and learn from user completion and execution of tasks, wherein the machine learning models are trained via execution data, supporting files, and demonstrations provided by the user, enabling the system to watch and learn from user behavior in real time including through audio and video meetings and other communications through and via the platform.

In addition to data captured through the workflow module and the other modules of the People OS suite, the AI Lab includes a dedicated agent training interface through which a user may train one or more AI agents on a one-to-one (1-1) basis with the machine, demonstrating tasks, skills, and goal-directed behavior directly to the platform host 11 outside of any particular client engagement. Each AI agent trained through the one-to-one (1-1) AI Lab agent training interface is registered with its own profile and digital ID, is bound to the training user’s digital ID, and is owned by the training user on a one-to-one (1-1) basis (such agents being referred to herein as “digital ID agents”), with ownership, lineage, and consent recorded in the provenance subsystem. The one-to-one (1-1) AI Lab agent training interface and the workflow module operate as complementary training surfaces: the workflow module captures collaborative and execution data during the double approval process and other multi-user activity, while the AI Lab agent training interface captures direct demonstration and instruction data from a single user. Data captured through the other modules of the People OS suite, including the onboarding module, the payments module, the digital skilling module, the learning e-commerce and learning programs module, the workspace module (including physical workspace interactions, booking, and mobility data), and the business services module, additionally informs and trains the AI agents and models, whether such modules are used in conjunction with the workflow module or in silo. In some embodiments, AI agents trained primarily on data and demonstrations captured within an Enterprise or People OS client deployment (“People OS agents”) are owned by the Enterprise or People OS client rather than by any individual worker, with such ownership, lineage, and consent likewise recorded in the provenance subsystem. Subject to the People OS client’s express approval, designated subsets of operational data, model adaptations, learned skills, and other artifacts generated within the People OS client deployment may be shared back, via the network sharing interface and under an executed network contract, to a worker’s digital ID for use in training that worker’s one-to-one (1-1) digital ID agents, with each such share recorded in the provenance subsystem.

The platform host 11 is configured to procure and govern third-party advanced AI models, including large language models (LLMs), foundational models, and models supporting artificial general intelligence (AGI) augmentation integrations, by wrapping them with adapters that enforce the platform’s tagging schema, privacy constraints, and policy gates. The platform host 11 can fine-tune or condition procured models using the proprietary context in the data lake. In this way, the system functions as an AI Lab and expert system that trains and delivers advanced AI via operations, demonstrations, and execution data captured on the platform, rather than merely providing machine learning for augmentation of existing functions. The proprietary advanced AI training infrastructure enables machine learning models to be trained to perform any type of skill or job as an advanced AI agent, achieving end-to-end execution of tasks including high-level and advanced tasks across all skill domains. These agents learn from AGI tools and agents connected to the system in addition to all other human and agent execution on the platform.

To support Section 101 compliance, the training pipeline is specified with concrete data structures including the ontology-mapped corpora and provenance indexes. The system achieves improvements to computer functionality and machine learning performance including reduced storage duplication via tagged corpora reuse, streamlined continual learning through incremental updates, and avoidance of catastrophic forgetting by policy-controlled rehearsal and task-specific adapters. These technical improvements anchor the inventive concepts to specific technological solutions.

### AI Agent Factory, Governance, and Ownership

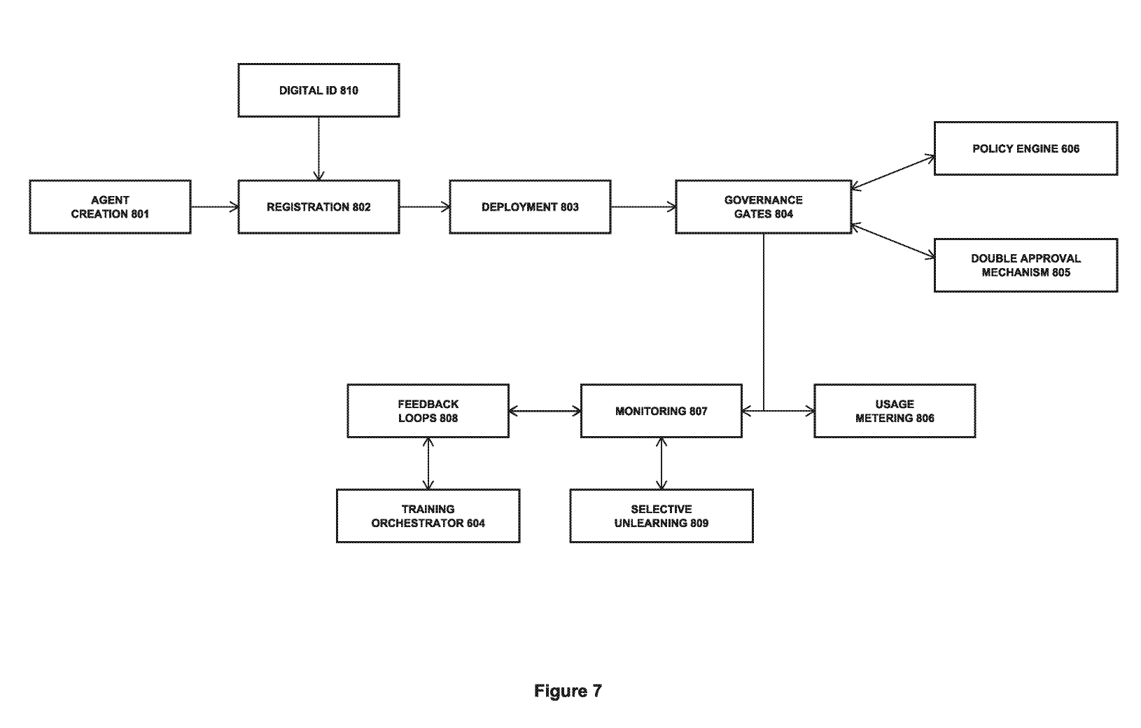

With reference to FIG. 7, shown is an agent lifecycle diagram according to an embodiment. The platform host 11 includes an agent factory that packages trained models as task-scoped AI agents with explicit capabilities, including interfaces to read and write workflow objects, propose milestones and edits, and generate approval recommendations, all under a policy engine that integrates the existing double approval mechanism as a human-in-the-loop gate. AI agents are addressable system entities with versioned artifacts and capability manifests registered in a model and agent registry maintained by the platform host 11. In some embodiments, AI agents function as digital providers, digital agents, or digital employees that can be assigned to tasks and projects in place of or alongside human providers, subject to the same workflow management and double approval mechanisms.

Users, including Clients and Providers, can be granted ownership and access rights to specific AI agents trained from their operational context, with lineage and consent recorded in the provenance subsystem. In some embodiments, an AI agent trained substantially from a particular Provider’s demonstrations, execution data, communications, and approved deliverables, or trained by the Provider through the one-to-one (1-1) AI Lab agent training interface described above, is designated as a Provider AI agent or digital ID agent owned by that Provider on a one-to-one (1-1) basis, such that the Provider AI agent constitutes a portable, assignable, licensable, pledgeable, and transferable digital asset bound to the Provider’s digital ID. In some embodiments, an AI agent trained substantially from operational context generated within an Enterprise or People OS client deployment is designated as a People OS agent owned by that Enterprise or People OS client rather than by any individual worker, and is bound to the People OS client’s account or organizational digital ID; subject to the People OS client’s express approval, designated People OS client-approved subsets of operational data, model adaptations, and learned skills generated within the People OS client deployment may be shared back to one or more workers’ digital IDs and used for training those workers’ one-to-one (1-1) digital ID agents, in each case via the network sharing interface, under an executed network contract, and with the share recorded in the provenance subsystem. Ownership is implemented as a combination of identity-bound entitlements linked to digital ID and licensing of model checkpoints and capability manifests under platform policies, and may include the right to use, reproduce, fine-tune, license, sublicense, lease, assign, sell, gift, bequeath, escrow, pledge, contribute as capital, or otherwise transfer the AI agent, in whole or in part, to another user, to the platform host, or to a third party, subject to platform policy and any underlying consent, licensing, or contractual constraints recorded in the provenance subsystem. In some embodiments, a worker maintains the worker’s digital ID and the worker’s associated one-to-one (1-1) digital ID agents within the worker’s per-user workflow module, and a Client or employer may discover and engage such digital ID agents in the same manner as the Client or employer engages a human Provider; upon engagement, the Client or employer pulls the engaged digital ID agents into a People OS instance, or into a similar deployment surface, so that human Providers, digital ID agents, People OS agents, and Clients or employers may collaborate together on the multi-module suite, including within the workflow module. In some embodiments, Providers whose demonstrations or execution data materially improve agent performance may receive equity or token incentives tracked via the provenance ledger, extending the equity issuance features described above with respect to blockchain-enabled payment processing.

Each transfer event for an AI agent, including any sale, assignment, license, sublicense, lease, escrow, gift, bequest, or contribution, is recorded by the provenance subsystem as a chain-of-title entry that cryptographically links the transferred model checkpoint, capability manifest, training-data lineage, governing consents, network contracts, and any policy or licensing constraints to the transferring user’s digital ID and to the receiving user’s digital ID. The platform host 11 propagates updated entitlements to the model and agent registry, revokes or rescopes access of the transferring party as specified by the transfer terms, and enforces post-transfer policy constraints, including any field-of-use restrictions, retraining restrictions, geographic or industry restrictions, and selective unlearning obligations associated with the transferred agent.

Governance includes safety and compliance checks, automated testing of agent behaviors on holdout tasks, and deployment guardrails that restrict autonomous execution to objectively verifiable subtasks while requiring affirmative approvals for subjective or high-risk actions through the double approval mechanism. This preserves and extends the double approval process described above by applying it as a governance gate for AI agent actions in addition to its original application to human provider-client interactions. The policy engine can be configured to evaluate the AI agent on holdout tasks and demonstrations and to block deployment if evaluation metrics or policy constraints are not met, recording outcomes in the registry and provenance subsystem.

### Workflow Orchestration and Agent Deployment

AI agents are deployed into the workflow runtime to co-pilot or execute tasks, propose or modify milestones and notes, and surface ranked provider matches, using the on-platform communication tools, calendaring, and time/screen tracking as both interfaces and telemetry sources for continuous improvement. When the agent completes a subtask, the double approval process records objective completion or routes the action for client approval, generating structured feedback that the training pipeline consumes. In this way, the workflow runtime and the AI training system form a closed loop in which operational data improves agent performance and agent actions generate new operational data.

If no suitable human provider match is found through the matching functionality described above, the system can generate job descriptions and post them via external sourcing APIs while concurrently instantiating a temporary AI agent to triage or pre-process deliverables until a replacement provider or human/agent assignment is identified or if preferred as the execution means of choice. This coupling integrates the existing external job board functionality with the new agent lifecycle and exemplifies the combination of reliable workflow execution with intelligent adaptation.

In some embodiments, the machine learning module and AI agents are configured to identify suitable replacement AI agents for particular tasks based on historical performance data and compatibility metrics when a provider is removed or unavailable, extending the replacement provider functionality described above to include AI agent replacements.

### Payments, Monetization, and Usage-Based AI Creation

The programmatic payment functionality described above continues to support traditional currency (including fiat-denominated transfers, credit and debit card processing, ACH, wire, and other conventional payment rails), tokenized mechanisms, and compatibility with cryptocurrency, and this functionality is extended to cover usage-based AI metering by allowing tokens, credits, traditional currency, subscription fees, software-as-a-service (SaaS) fees, or other recurring or one-time charges to cover agent training cycles, inference usage, or hybrid workflows that combine agent effort and provider labor. Ledger entries for AI usage are mapped to provenance and audit trails. The combination of software-as-a-service, subscription-based, and usage-based AI creation and leverage, alongside traditional currency, tokenized, and cryptocurrency-compatible payment options, implements an AI-native business model within the previously disclosed programmable payment framework.

In some embodiments, pricing differentiates between data ingestion and tagging, training jobs, agent deployment, and inference actions, with optional equity or token incentives to providers when their demonstrations or execution data materially improve agent performance, tracked via the provenance ledger to support transparent revenue sharing. Unused tokens for AI usage, like unused tokens for provider payment, can be retained by the client and applied to other tasks, milestones, AI training jobs, or different providers or agents.

### Integrations, Interoperability, and External Interfaces

The platform host 11 continues to interoperate with ATS, VMS, and HRM/HRIS systems and sourcing APIs as described above, and additionally provides standardized adapters that map external schemas to the platform’s tagging ontology and provenance requirements. Job board posting, external clearinghouses for credential verification, and bidirectional enterprise integrations remain supported and now feed agent training corpora and deployment surfaces. In some embodiments, sensitive enterprise task data received via secure APIs may optionally be processed transiently in volatile memory at the platform host 11 during feature computation, with agent packaging artifacts and derived features stored with lineage; such transient processing is offered as an optional configuration and is not the default behavior. In Some embodiments, purging of data, derived corpora, model checkpoints, and AI agents from the platform host 11 is not performed by default; rather, ingested data, derived corpora, model checkpoints, and AI agents are retained in accordance with applicable network contracts and provenance entries, and are purged only upon deletion of, or a request to delete, the corresponding data or AI agent by an authorized data holder, agent owner, or other party with the appropriate entitlement recorded in the provenance subsystem.

### Security, Privacy, and Data Provenance

The provenance subsystem described above ensures immutable lineage for training and inference events, consent states, and model/agent versions. Digital IDs consolidate verified identity, credentials, and entitlements, while agent manifests encode permitted scopes and required approvals, enabling cryptographically auditable operations across the agent lifecycle. Automated policy enforcement checks training datasets for scope and consent, prevents leakage of restricted information to models lacking authorization, and supports selective unlearning by enumerating lineage of affected features and corpora. These are technical controls that improve reliability and safety of AI systems operating in enterprise workflows. In embodiments supporting private and closed-source AI assets, the platform host 11 enforces isolation boundaries between user-designated servers and shared network resources, ensuring that data, ML models, FMs, and LLMs marked as private remain inaccessible to external platforms unless and until the user affirmatively elects to share via the network sharing interface. Network contracts executed upon sharing define the scope of permitted use, retention periods, and conditions for access revocation, and are cryptographically linked to access control entries in the provenance subsystem.

### Digital Skilling and Tech-Enabled Workflow Module

In some embodiments, the platform host 11 is configured with digital skilling functionality comprising a tech-enabled workflow module in which users can complete training, orientation, learning, development, and preparation tasks, as referenced above, within an interactive environment that captures user interactions as demonstration data. The digital skilling functionality leverages the data lake and tagging pipeline to record skill acquisition sequences and competency assessments, which are then available as training data for AI agents specializing in similar task domains. The tech-enabled workflow module integrates with the communication tools, document management, and scheduling functionality described above to provide a comprehensive digital environment for user skill development and AI training data capture. In some embodiments, the digital skilling functionality supports fine-tuning of humans, AI agents, and AI and LLMs to perform in an advanced capacity by providing structured learning paths, competency tracking, and adaptive training recommendations generated by the AI agents.

### Workspace Module

In some embodiments, the People OS suite further includes a workspace module, distinct from the workflow module described above, that enables on-platform booking and management of physical workspaces such as pods and workstations and that supports mobility tracking and mobility enablement for users moving between physical locations. The workspace module connects to physical workspace assets and to a related product or system that addresses such physical workspaces, and surfaces booking, occupancy, and mobility data through the platform host 11. Interaction data captured through the workspace module is routed through the tagging and enrichment pipeline to the data lake under the provenance subsystem and informs training of the AI agents and models. The digital collaboration and training functionality of the workflow module, the digital skilling functionality described above, and the physical workspace booking and mobility functionality of the workspace module operate as separate but interoperable modules within the People OS suite, and the workspace module may be used in silo or in conjunction with the workflow module and other modules of the suite.

### Nested User Interface Architecture, Multi-Folder Workspaces, and Tiered Compute and Storage

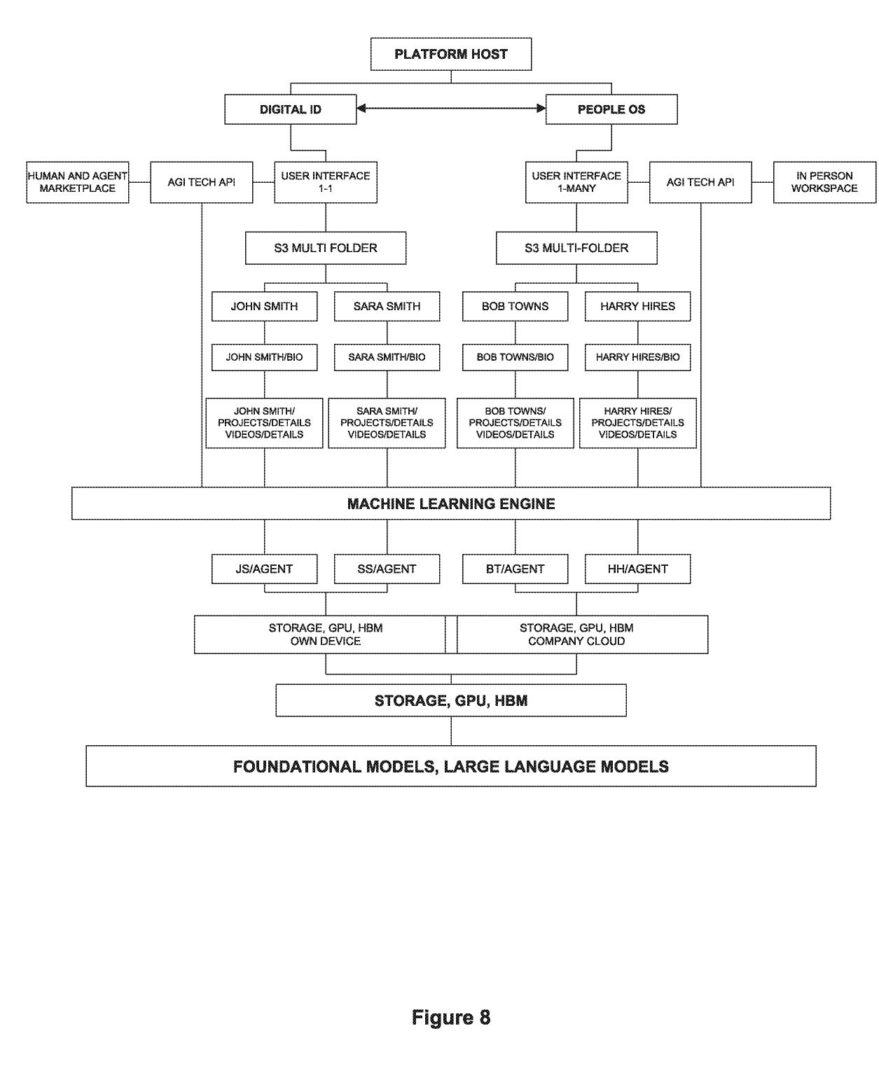

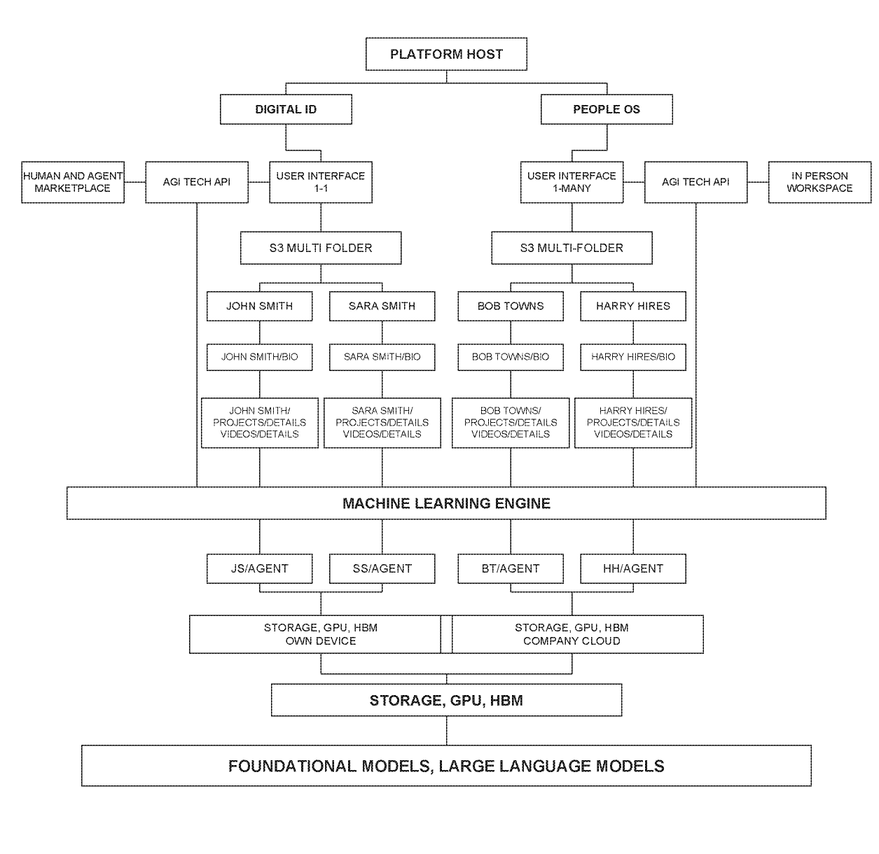

With reference to FIG. 8, in some embodiments, the interactive graphical user interface served by the platform host 11 to user devices 10 is organized as a plurality of nested user interface layers. The nested user interface layers comprise a top-level platform user interface that exposes platform-wide navigation and configuration, a people operations user interface presented within the top-level platform user interface and providing access to the workflow management, double approval, on-platform communication, scheduling, time and screen tracking, and programmatic payment functionality described above, and a human and AI agent marketplace user interface presented within the people operations user interface and through which Clients can discover, compare, and engage Providers and AI agents. The nested user interface layers cooperate such that registration data, role assignments (including Client and Provider roles and AI agents functioning as digital providers, digital agents, or digital employees as described above), entitlements derived from the digital ID, and policy constraints enforced by the policy engine are inherited across layers without requiring re-authentication or duplicative data entry.

In some embodiments, the platform user interface further presents a technology and innovation workspace user interface accessible from within the top-level platform user interface, in which Clients, Providers, and AI agents can access and interact with the digital skilling functionality, document management, communication tools, demonstration capture, and AI agent procurement and deployment surfaces described above. The technology and innovation workspace user interface is configured to surface AI agents, large language models, foundational models, and tools made available via the agent factory, model and agent registry, and procurement interface, and to capture user interactions within the workspace as demonstration data routed through the tagging and enrichment pipeline to the data lake under the provenance subsystem.

In some embodiments, each registered user, including each human Client, each human Provider, and each AI agent functioning as a digital provider, digital agent, or digital employee, is assigned within the human and AI agent marketplace user interface a per-user workspace organized as a multi-folder data structure. The per-user workspace comprises a plurality of folders including (i) a biographical folder containing the user’s digital resume and digital ID, including verified skills, credentials, identity attributes, entitlements, and performance metrics validated against external clearinghouses or service bureaus as described above; (ii) a project folder containing task records, milestone notes and deliverables, double approval entries, time and screen tracking records, and budget-versus-actual hour traces associated with that user; and (iii) a recordings folder containing audio and video communications, meeting recordings, screen captures, and demonstrations generated through the on-platform communication tools and digital skilling functionality described above. Additional folders may be provided for payment and tokenization records, network sharing and network contract records, and provenance and lineage indices. The multi-folder data structure for each AI agent mirrors the multi-folder data structure for each human user, such that human Providers and AI agents are addressable, browsable, and selectable through a common representation within the human and AI agent marketplace user interface and may be compared and assigned to tasks and projects through the matching and ranking functionality and double approval mechanism described above.

In some embodiments, the platform host 11 cooperates with a tiered compute and storage architecture comprising a plurality of compute and storage tiers across which the data lake, machine learning (ML) models, foundational models (FMs), large language models (LLMs), AI agents, per-user workspaces, and provenance records described above may be hosted, trained, fine-tuned, and executed. The tiered compute and storage architecture comprises (i) a user device tier comprising local storage and compute at the user device 10, including local memory, processing, and where present graphics processing unit (GPU) and high-bandwidth memory (HBM) resources, configured to host on-device user data, on-device demonstrations, and on-device inference for designated AI agents; (ii) a client- or provider-controlled tier comprising non-volatile storage, GPU acceleration, and HBM resources located on designated client, talent, or provider servers as described above with respect to the distributed and privacy-preserving architecture, configured to host private data, ML models, FMs, LLMs, and AI agents that the user has elected to maintain on user-controlled infrastructure; and (iii) a platform-controlled cloud tier comprising cloud storage, GPU acceleration, and HBM resources hosted at or accessible to the platform host 11, configured to host shared data, shared ML models, shared FMs, shared LLMs, and shared AI agents made available through the procurement interface, agent factory, and model and agent registry described above.

In some embodiments, the assignment of data, ML models, FMs, LLMs, AI agents, and per-user workspace folders across the user device tier, the client- or provider-controlled tier, and the platform-controlled cloud tier is governed by user-configurable settings exposed through the network sharing interface described above, with the policy engine enforcing isolation boundaries between tiers and the provenance subsystem recording the tier assignment, sharing scope, network contract execution, and any subsequent migration or revocation as lineage entries. In this way, a user may, through the network sharing interface, elect to retain a private LLM, FM, or AI agent on a user-controlled server within the client- or provider-controlled tier, to mirror or replicate selected artifacts to the platform-controlled cloud tier for shared use, or to expose selected artifacts to all on-network platforms or to designated on-network platforms, with executed network contracts and revocation events stored in the provenance subsystem and propagated to the model and agent registry as described above.

In some embodiments, AI agents owned by users, including digital ID agents owned by individual one-to-one (1-1) workers and People OS agents owned by an Enterprise or People OS client, may be pushed by the platform host 11 to user-controlled infrastructure for local hosting, execution, or archival. For one-to-one (1-1) users, an owned digital ID agent may be pushed to one or more private servers designated by the user and downloaded to the user’s desktop, server, or designated storage folder for on-device or on-server use. For enterprise or People OS client users, an owned People OS agent may be downloaded and stored to a private cloud environment or on-premises server designated by the Enterprise or People OS client. Alternatively, in some embodiments, both one-to-one (1-1) users and enterprise or People OS client users may elect to store and host their owned AI agents on a storage network maintained by or accessible to the platform host 11, with the storage network operating as part of the platform-controlled cloud tier described above. In each case, the migration, copy, or download of the owned AI agent is governed by user-configurable settings exposed through the network sharing interface, recorded as a lineage entry in the provenance subsystem (including source tier, destination tier, executed network contract, and any field-of-use, retraining, or geographic restrictions), and reflected in the model and agent registry as updated entitlements and deployment surfaces.

### Example Embodiments of AI-Native Operations

In a first example embodiment, a client launches a new engagement; the provider records a demonstration of a complex review task using the platform’s document management and communication tools; the tagging pipeline categorizes the demonstration and associated approvals into labeled sequences; the training orchestrator fine-tunes a foundational model to create an AI agent that can pre-structure deliverables and propose milestone notes; the policy engine restricts autonomous actions to objective subtasks and requires approvals for subjective edits; and usage-based payments remit both to the provider and to platform AI usage, with provenance linking contributions to outcomes. This illustrates the end-to-end path from human behavior to deployable AI agent in total people operations.

In a second example embodiment, an enterprise with an external ATS pipeline continues to post roles via job boards; when no match is found, the platform instantiates a temporary AI agent that triages inbound applications and summarizes communications, while the sourcing API posts refined descriptions and the platform targets replacement providers; all actions are logged in the provenance subsystem and routed through the double approval mechanism to maintain accountability and safety. This demonstrates integrated sourcing and AI agent operations within the existing API framework, including via internal systems such as an internal job marketplace.

In a third example embodiment, the platform operates as an advanced AI training and procurement system in which multiple clients and providers contribute operational and demonstration data to the data lake; the training orchestrator produces task-specific AI agents that are registered in the model and agent registry; clients can procure access to agents trained on relevant operational contexts; and providers whose data materially contributed to agent performance receive token-based, traditional currency, or subscription-based compensation tracked through the provenance ledger. This embodiment illustrates the platform functioning as an AI Lab with its own training system that trains and delivers advanced AI via operations and demonstrations and execution data, operating as a rare combination of software-as-a-service, subscription-based, and usage-based AI creation and leverage, with payments processable in traditional currency, tokenized, or cryptocurrency-compatible form.

### Explanation of Computing Environment

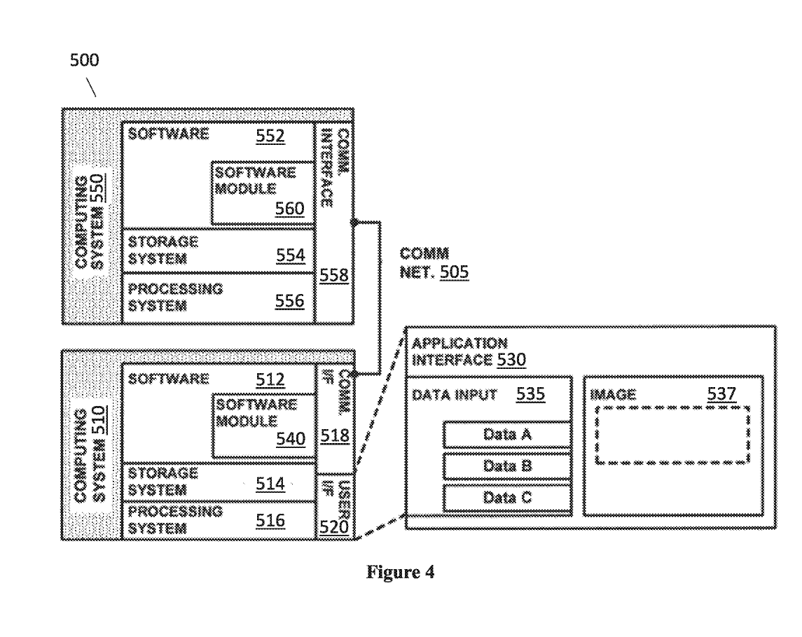

FIG. 4 illustrates a computing environment 500 according to one embodiment. Computing environment 500 includes computing system 510 and computing system 550. Computing system 510, in the present example, corresponds to user devices 10 that can send and receive data and information, and computing system 550 corresponds to system platform host 11 that can also send and receive data and information. Computing system 510 can include any smart phone, tablet computer, laptop computer, or other computing or mobile device capable of reading, and/or recording data about systems, devices, locations, and/or equipment, etc. Computing system 550 can include any server computer, desktop computer, laptop computer, or other device capable of storing and managing data communication by and between one or more computing systems 510 and other similar computing systems. Either system 510 or 550 can be capable of accomplishing any of the steps or functions described in this description.

In FIG. 4, computing system 510 includes processing system 516, storage system 514, software 512, communication interface 518, and user interface 520. Processing system 516 loads and executes software 512 from storage system 514, including software module 540. When executed by computing system 510, software module 540 directs processing system 516 to receive data, images, devices, locations, and/or equipment, etc. Such data could include any of the information described above, including but not limited to the functionality described herein.

Although computing system 510 includes one software module in the present example, one or more modules could provide the same operation. Similarly, the computing systems may be distributed using other computing systems and software.

Additionally, computing system 510 includes communication interface 518 that can be further configured to transmit data to and receive data from computing system 550 using communication network 505 (which represents the communications network 105 shown in FIG. 1). Communication network 505 could include the Internet, cellular network, satellite network, RF communication, Bluetooth-type communication, near field, or any other form of communication network capable of facilitating communication between computing systems 510 and 550.

Referring still to FIG. 4, processing system 516 can comprise a microprocessor and other circuitry that retrieves and executes software 512 from storage system 514. Processing system 516 can be implemented within a single processing device but can also be distributed across multiple processing devices or sub-systems that cooperate in executing program instructions. Examples of processing system 516 include general purpose central processing units, application specific processors, and logic devices, as well as any other type of processing device, combinations of processing devices, or variations thereof. Storage system 514 can comprise any storage media readable by processing system 516, and capable of storing software 512. Storage system 514 can include volatile and nonvolatile, removable and non-removable media implemented in any method or technology for storage of information, such as computer readable instructions, data structures, program modules, or other data. Storage system 514 can be implemented as a single storage device but may also be implemented across multiple storage devices or sub-systems. Storage system 514 can comprise additional elements, such as a controller, capable of communicating with processing system 516.

Application interface 530 can include data input 535 and image display 537. In one example, data input 535 can be used to collect information and data inputs from the user. It should be understood that although computing system 510 is shown as one system, the system can comprise one or more systems to collect data.

Computing system 550 includes processing system 556, storage system 554, software 552, and communication interface 558. Processing system 556 loads and executes software 552 from storage system 554, including software module 560. When executed by computing system 550, software module 560 directs processing system 556 to store and manage the data from computing system 510 and other similar computing systems. Although computing system 550 includes one software module in the present example, it should be understood that one or more modules could provide the same operation.

Additionally, computing system 550 includes communication interface 558 that can be configured to send and receive data to and from computing system 510 using communication network 505.

Referring still to FIG. 4, processing system 556 can comprise a microprocessor and other circuitry that retrieves and executes software 552 from storage system 554. Processing system 556 can be implemented within a single processing device but can also be distributed across multiple processing devices or sub-systems that cooperate in executing program instructions. Examples of processing system 556 include general purpose central processing units, application specific processors, and logic devices, as well as any other type of processing device, combinations of processing devices, or variations thereof.

Storage system 554 can comprise any storage media readable by processing system 556, and capable of storing software 552 and data from computing system 510. Data from computing system 510 may be stored in a word, excel, or any other form of digital file. Storage system 554 can include volatile and nonvolatile, removable and non-removable media implemented in any method or technology for storage of information, such as computer readable instructions, data structures, program modules, or other data. Storage system 554 can be implemented as a single storage device but may also be implemented across multiple storage devices or sub-systems. Storage system 554 can comprise additional elements, such as a controller, capable of communicating with processing system 556.

Examples of storage media include random access memory, read only memory, magnetic disks, optical disks, flash memory, virtual memory, and non-virtual memory, magnetic cassettes, magnetic tape, magnetic disk storage or other magnetic storage devices, or any other medium which can be used to store the desired information and that may be accessed by an instruction execution system, as well as any combination or variation thereof, or any other type of storage media. In some implementations, the storage media can be a non-transitory storage media. In some implementations, at least a portion of the storage media may be transitory. In no case is the storage media a propagated signal.

In some examples, computing systems 510 and 550 can include a user interface. The user interface can include a mouse, a keyboard, a voice input device, a touch input device for receiving a gesture from a user, a motion input device for detecting non-touch gestures and other motions by a user, and other comparable input devices and associated processing elements capable of receiving user input from a user. Output devices such as a graphical display, speakers, printer, haptic devices, and other types of output devices may also be included in the user interface. The user input and output devices are well known in the art and need not be discussed at length here.

The included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., the use of a certain component described above alone or in conjunction with other components may comprise a system, while in other aspects the system may be the combination of all of the components described herein, and in different order than that employed for the purpose of communicating the novel aspects of the present disclosure. Other variations and modifications may be within the skill and knowledge of those in the art, after understanding the present disclosure. This method of disclosure is intended to obtain rights which include alternative embodiments to the extent permitted, including alternate, interchangeable and/or equivalent structures, functions, ranges or steps to those claimed, whether such alternate, interchangeable and/or equivalent structures, functions, ranges or steps are disclosed herein, and without intending to publicly dedicate any patentable subject matter.

What is claimed is:

1. A system comprising:
1a. a platform host with at least one processor and memory in communication with user devices over a network, the platform host executing a workflow runtime that manages tasks with a milestone-based double approval mechanism and on-platform collaboration and communications;
1b. a data lake storing operational workflow events, milestone notes and deliverables, time and screen tracking data, communications content and metadata, programmatic payment confirmations, and provider demonstrations and execution logs captured within the workflow runtime;
1c. a tagging and enrichment pipeline that categorizes the stored data to a task and skill ontology to produce machine-learning-ready corpora and feature vectors with lineage entries;
1d. a provenance subsystem that records consent, lineage, and model and agent versioning for artifacts in the data lake and corpora, optionally anchored using blockchain-enabled features;
1e. a training orchestrator configured to train or fine-tune advanced AI models using the corpora, including models selected from foundational models and large language models; and

2. The system of claim 1, wherein the training orchestrator supports supervised learning on historical outcomes, imitation learning from demonstrations, and feedback learning derived from milestone approvals and rejections logged by the double approval mechanism, and wherein the training orchestrator observes and learns from user completion and execution of tasks such that the advanced AI models are trained via execution data, supporting files, and demonstrations provided by the user, enabling the system to watch and learn from user behavior in real time.

3. The system of claim 1, wherein the advanced AI models comprise large language models and foundational models obtained via a procurement interface and adapted to the ontology using platform-tagged corpora, and wherein the platform host functions as an expert system that directly feeds operational data and learned patterns into a proprietary advanced AI training infrastructure comprising the data lake, the tagging and enrichment pipeline, the provenance subsystem, the training orchestrator, and the agent factory, providing users with the advanced AI models and artificial general intelligence training, creation, ownership, and augmentation capabilities.

4. The system of claim 1, wherein the provenance subsystem anchors lineage entries to a blockchain-backed append-only log that also supports tokenized programmatic payments.

5. The system of claim 1, further comprising a model and agent registry storing versioned checkpoints, capability manifests, evaluation metrics on holdout tasks, and deployment entitlements linked to digital IDs.

6. The system of claim 1, wherein the platform host integrates with one or more of an applicant tracking system, a vendor management system, a human resources management platform, an external sourcing API, or any additional internal or external tech stack or interface, and wherein the AI agents consume and contribute to those systems via standardized adapters mapped to the tagging ontology.

7. The system of claim 1, wherein the training orchestrator and tagging pipeline support selective unlearning by identifying and removing features and training samples associated with rescinded consent via lineage traversal in the provenance subsystem.

8. The system of claim 1, wherein sensitive enterprise task data received via secure APIs may optionally be processed transiently in volatile memory during feature computation, and wherein purging of data, derived corpora, model checkpoints, and AI agents from the platform host is not performed by default and instead occurs only upon deletion of, or a request to delete, the corresponding data or AI agent by an authorized data holder or agent owner.

9. The system of claim 1, wherein the agent factory supports instantiation of replacement AI agents for particular tasks based on historical performance data and compatibility metrics when a provider is removed or unavailable, and wherein AI agents function as digital providers, digital agents, or digital employees that are assignable to tasks and projects in place of or alongside human providers, subject to the workflow management and double approval mechanisms.

10. The system of claim 1, further comprising digital skilling functionality comprising a tech-enabled workspace in which users complete training, orientation, learning, development, and preparation tasks within an interactive environment that captures user interactions as demonstration data for training AI agents, and wherein the platform host constructs a digital resume aggregating verified skills, credentials, task history, and performance metrics for each user, and a digital ID consolidating verified identity, credentials, and entitlements for each user, derived from one or more data points or the data lake and validated against one or more external clearinghouses or service bureaus.

11. The system of claim 1, wherein the training orchestrator is configured to train the advanced AI models to perform any type of skill or job as an advanced AI agent, achieving end-to-end execution of tasks including high-level and advanced tasks across all skill domains.

12. The system of claim 1, wherein the platform host supports a distributed and privacy-preserving architecture wherein each platform and module maintains its own private data, machine learning models, foundational models, and large language models on designated client, talent, or mothership servers, with blockchain-enabled features offered as optional additions; wherein the platform host further comprises a network sharing interface through which users selectively share data and models with all on-network platforms or with designated on-network platforms; wherein sharing is recorded in the provenance subsystem and is revocable at any time with access termination propagated to affected network platforms; and wherein prior to sharing to each network the platform host generates a network contract for digital review and electronic signature by the user, with executed network contracts stored in the provenance subsystem.

13. A computer-implemented method comprising:
13a. ingesting, at a platform host, workflow events, milestone approvals and rejections, notes and deliverables, communications, programmatic payment confirmations, and provider demonstrations collected during execution of a milestone-based double approval process;
13b. tagging the ingested data according to a task and skill ontology to form corpora with feature vectors and lineage metadata recorded in a provenance subsystem;
13c. training or fine-tuning at least one advanced AI model using the corpora to produce a task-scoped AI agent;
13d. packaging the trained model as the task-scoped AI agent with a capability manifest and deployment policies enforced by a policy engine integrated with the double approval mechanism;
13e. deploying the agent into the workflow runtime to co-pilot or execute tasks and to generate objective completion signals or approval recommendations; and
13f. metering and remitting programmatic payments for agent training and inference using one or more of traditional currency, tokenized, cryptocurrency-compatible, subscription-based, or software-as-a-service-based mechanisms.

14. The method of claim 13, further comprising performing real-time incremental training updates to the AI agent using newly ingested and tagged workflow events and demonstrations with lineage recorded in the provenance subsystem.

15. The method of claim 13, wherein deploying the agent includes restricting autonomous execution to subtasks having predetermined objective completion criteria and routing proposed subjective actions through the double approval mechanism.

16. The method of claim 13, wherein ownership and access rights to the AI agent are granted to a client or provider associated with the demonstrations and execution data used for training, as recorded in the provenance subsystem.

17. The method of claim 13, wherein the tagging ontology includes labels for task schemas, skill taxonomies, approval categories, and outcome types, enabling consistent feature extraction from heterogeneous workflow and communications data.

18. A non-transitory computer-readable medium storing instructions that, when executed by one or more processors of a platform host, cause the platform host to:
18a. maintain a data lake of operational and demonstration data tagged to an ontology with lineage;
18b. train or fine-tune an advanced AI model to produce an AI agent;
18c. register the AI agent with a capability manifest;
18d. enforce deployment policies using a policy engine integrated with a double approval mechanism;
18e. interface the AI agent with workflow and communications tools to perform objective subtasks autonomously and to generate approval recommendations for subjective tasks; and
18f. meter and settle programmatic payments for training and inference usage using one or more of traditional currency, tokenized, cryptocurrency-compatible, subscription-based, or software-as-a-service-based mechanisms.

19. The non-transitory computer-readable medium of claim 18, wherein the instructions further cause the platform host to retrieve consented context from the data lake according to the capability manifest to condition agent outputs during task execution.

20. The non-transitory computer-readable medium of claim 18, wherein the instructions cause the platform host to evaluate the AI agent on holdout tasks and demonstrations and to block deployment if evaluation metrics or policy constraints are not met, recording outcomes in the registry and provenance subsystem.
